(19) United States
(12) Patent Application Publication
(10) Pub. No.: US 2013/0097507 A1
(43) Pub. Date: Apr. 18, 2013

(54) FILMSTRIP INTERFACE FOR SEARCHING VIDEO

(71) Applicant: Geoffrey Prewett, Beijing (CN)

(72) Inventor: Geoffrey Prewett, Beijing (CN)

(73) Assignee: UTC FIRE AND SECURITY CORPORATION, Farmington, CT (US)

(21) Appl. No.: 13/275,937

(22) Filed: Oct. 18, 2011

(51) Int. Cl. G06F 3/01

(52) U.S. Cl. 715/720

(57) ABSTRACT

An interface for searching and playing recorded video comprises a filmstrip snapshot sequence, a selection window, a first input device, a second input device, and a third input device. The filmstrip snapshot sequence comprises chronologically ordered snapshots associated with video segments of the recorded video. The snapshots are taken at regular intervals that may be equal to the length of the video segments. The selection window highlights consecutive snapshots from the filmstrip snapshot sequence. The first input device advances the filmstrip snapshot sequence, causing the selection window to highlight a chronologically later set of snapshots. The second input device zooms in on the filmstrip snapshot sequence as a function of time, causing a new set of snapshots to be retrieved at a smaller regular interval. The third input device causes the video segments associated with the highlighted snapshots to be played.

### BACKGROUND

The present invention relates generally to video searching, and more particularly to a search interface for locating a transition event in recorded video.

Video surveillance commonly produces a large volume of recorded video, of which only a few minutes or a few seconds may be of interest in the event of a theft or incident. A camera in an art museum, for instance, might capture several hours of footage of normal activity on a night a painting is stolen, while the theft itself might only appear on recorded video for a minute or less. Many events—herein referred to as transition events—cause a persistent change in an environment under surveillance. Playing through large volumes of video to find such events can be time consuming and imprecise.

### SUMMARY

The present invention is directed toward a user interface for searching and playing recorded video, a network comprising a client device which runs the user interface, and a method for searching and playing recorded video using the user interface. The user interface comprises a filmstrip snapshots sequence, a selection window, a first input device, a second input device, and a third input device. The filmstrip snapshot sequence comprises a series of chronologically ordered snapshots of the recorded video, each snapshot having an associated video segment of the recorded video from which the snapshot was taken. Each of the snapshots is taken at a regular interval equal to the length of the video segments. The selection window highlights a set of at least two consecutive snapshots from the filmstrip snapshot sequence. The first input device advances the filmstrip snapshot sequence when activated, causing the selection window to highlight a chronologically later set of snapshots. The second input device zooms in on the filmstrip snapshot sequence as a function of time when activated, causing a new set of snapshots to be retrieved at a smaller regular interval. The third input device plays the video segments associated with the highlighted snapshots, in chronological order, when activated.

### BRIEF DESCRIPTION OF THE DRAWINGS

FIG. 1 is a block diagram of a video capture and replay network.

FIG. 2 is a simulated screenshot of a graphical user interface used to search video in the video capture and replay network of FIG. 1.

FIG. 3A and 3B are timelines of video segments represented by the graphical user interface of FIG. 2 at a low and a high zoom level, respectively.

FIG. 4 is a flowchart of a method for searching video using the graphical user interface of FIG. 2.

### DETAILED DESCRIPTION

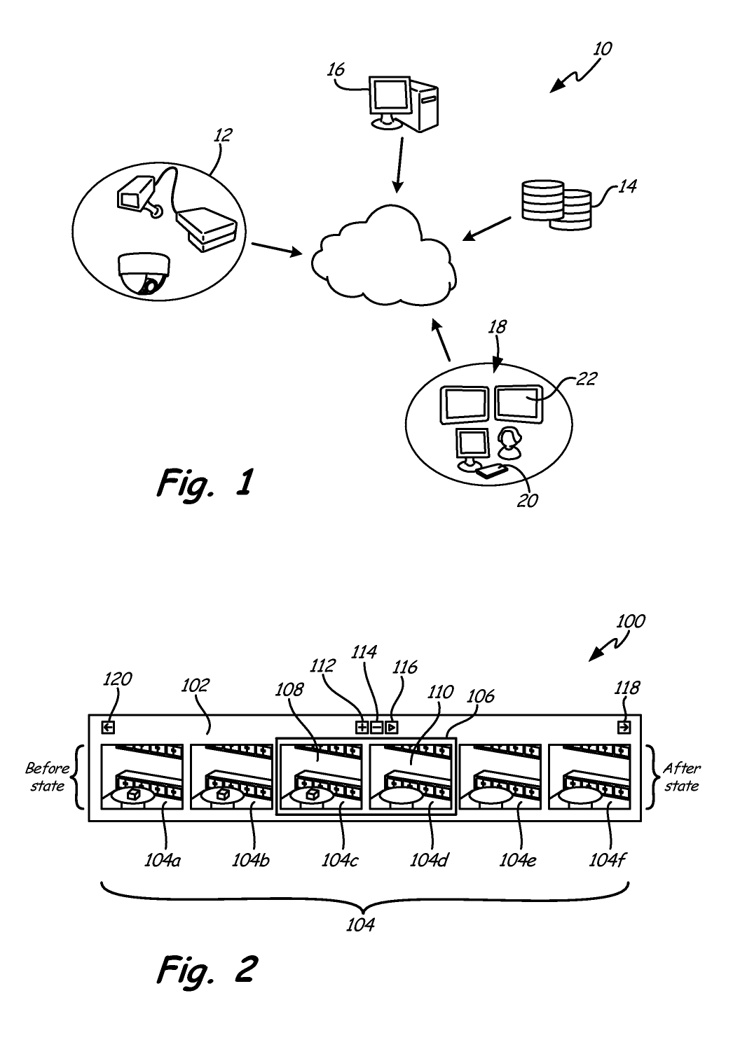

FIG. 1 is a block diagram of video capture and playback network 10, comprising source 12, recorder 14, local server 16, and client device 18 with interface device 20 and playback monitor 22. Source 12 is a video source such as a digital camera. Although only one source 12 is shown, many video sources may be included in video capture and playback network 10. Recorder 14 is a video recorder which encodes real time video from source 12, and stores encoded video in a machine-readable format. In some embodiments source 12 and recorder 14 may communicate directly, while in other embodiments recorder may receive video from source 12 only through video capture and playback network 10. Although only one recorder 12 is shown, many video recorders may be included in video capture and replay network 10, potentially including multiple recorders which encode video from source 12, as well as multiple recorders which encode video from other sources. Local server 16 is a video management server which may catalogue, retrieve, or process video from recorder 14 for playback at client device 18. Alternatively, local server 16 may catalogue video from recorder 14 and provide configuration information enabling client device 18 to directly retrieve and play back video from recorder 14. Client device 18 is a logic-capable user-side device such as a personal computer, through which a user may search, manipulate, or play back video from recorder 14. Client device 18 includes at least one interface device 20 to allow user input, and at least one playback monitor 22 to display video from recorder 14. Local server 16 and client device 18 are computers with processors and hardware memory, and may be either specialized hardware computers or general purpose computers running specialized software for video management and processing. In some embodiments, local server 16, recorder 14, and client device 18, or some combination thereof, may be logically separable parts of a single hardware computer.

Users at client device 18 can review video collected by source 12 and stored at recorder 14. Client device 18 runs graphical user interface (GUI) 100 on local memory, as depicted and described below with respect to FIG. 2. GUI 100 facilitates rapidly and easily searching, retrieving, and playing back recorded video from the period of interest, as described below.

FIG. 2 is a simulated screenshot of graphical user interface 100 for client device 18. Graphical user interface (GUI) 100 features filmstrip panel 102 displaying filmstrip snapshot sequence 104 (including filmstrip snapshots 104a, 104b, 104c, 104d, 104e, and 104f), selection window 106 (enclosing first selected image 108 and second selected image 110), zoom-in input device 112, zoom-out input device 114, play input device 116, forward input device 118, and reverse input device 120. Filmstrip panel 102 is a region of graphical user interface 100 devoted to source 12, and displays filmstrip snapshot sequence 104. Filmstrip snapshots 104a-104f are chronologically arranged images taken at regular time intervals from recorded video originated at source 12, and stored at recorder 14. Filmstrip snapshots 104a-104f are retrieved from recorder 14 by client device 18, over video capture and playback network 10. In some embodiments client device 18 retrieves filmstrip snapshots 104a-104f from recorder 14 without input from local server 16 (see FIG. 1). In other embodiments, client device 18 requests filmstrip snapshots 104a-104f from video local server 16, which may either retrieve and forward filmstrip snapshots 104a-104f to client device 18, or provide instructions to client device 18 which enable client device 18 to retrieve filmstrip snapshots 104a-104f directly from recorder 14.

In some embodiments the input devices described herein are buttons activated by pressing or clicking on a pre-defined area. Such buttons may include zones on a touch screen, GUI regions which react to mouse clicks, or physical keys. In other embodiments these input devices are cursor movements or cursor swipes. Although buttons 112, 114, 116, 118, and 120 are depicted as GUI buttons situated on filmstrip panel 102, alternative embodiments may use other input means well known in the art, such as keyboard hotkeys or drop-down menus. The terms “input device” or “button” refer herein to any such mouse click, mouse swipe, touch screen zone, physical keyboard hotkey, drop-down menu, or other conventional input device.

In the depicted embodiment, filmstrip snapshot sequence 104 is arranged such that earlier images appear to the left of later images, forming a filmstrip which extends in chronological order from left to right. Filmstrip snapshot sequence 104 may alternatively be positioned in other arrangements which preserve the order of filmstrip snapshots 104a-104f, such as chronologically from top to bottom, or chronologically from right to left. Although filmstrip snapshot sequence 104 is shown in FIG. 2 as forming a single row extending across filmstrip panel 102, filmstrip snapshot sequence 104 may in some embodiments be arranged in multiple rows or columns.

Filmstrip snapshots 104a-104f originate from source 12. In some embodiments, further filmstrip panels containing filmstrip snapshot sequences associated with another source may be arranged adjacent to filmstrip panel 102. In some embodiments, graphical user interface 100 may include a menu, button, drag-and-drop list, or other selection means (not shown) for controlling which source is represented in filmstrip panel 102.

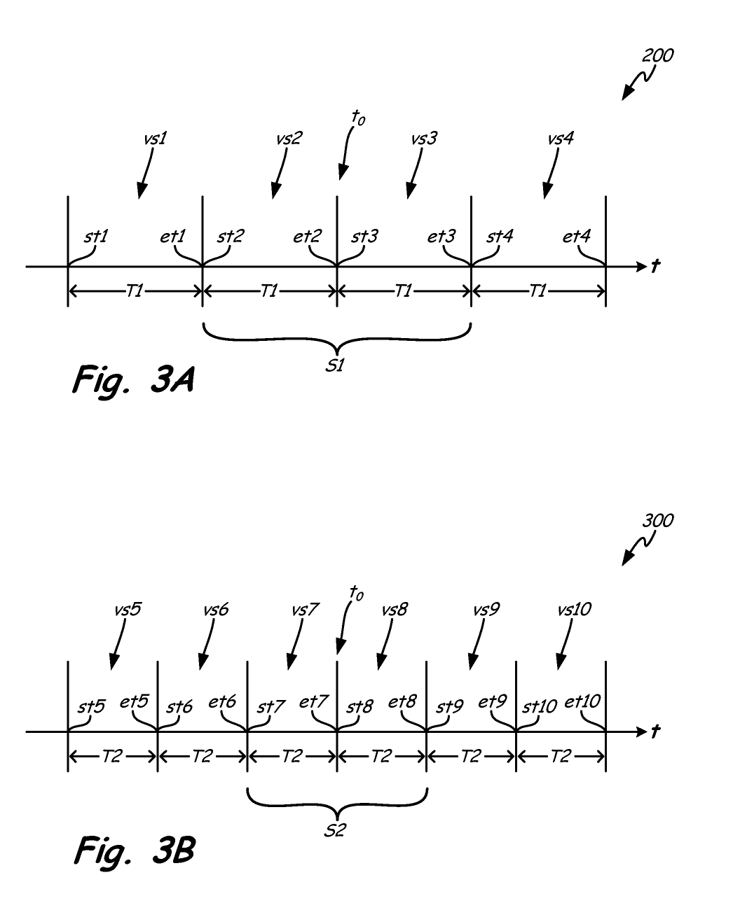

First selection image 108 and second selection image 110 are adjacent images enclosed by selection window 106. In FIG. 2, first selection image 108 is filmstrip snapshot 104c, while second selection image 110 is selection image 104d. Although only two selection images are shown in FIG. 2, some embodiments may enclose additional images within selection window 106. Selection window 106 may be a frame surrounding selected images, a tint applied to selected or unselected images, or any other means of visually highlighting selected images. Each filmstrip snapshot 104N (i.e. 104a, 104b, . . . or 104f) corresponds to a video segment which begins with, ends with, or otherwise includes corresponding filmstrip snapshot 104N, and has a duration equal to the interval between filmstrip snapshots 104N. Where filmstrip snapshots 104a-104f are taken at one hour intervals from security camera footage, for instance, each filmstrip snapshot 104N will be associated with an hour-long video segment. Client device 18 retrieves video segments from recorder 14 via video capture and playback network 10. In some embodiments, client device 18 may retrieve video segments corresponding to each filmstrip snapshot 104a-104f when each filmstrip snapshot is retrieved; in such embodiments, filmstrip snapshots 104a-104f may be extracted from corresponding video segments by client device 18. Alternatively, client device 18 may only retrieve video segments corresponding to filmstrip snapshots in selection window 106 (i.e. first selected image 108 and second selected image 110) when play input device 116 is pressed (as described below), thereby conserving bandwidth. As with filmstrip snapshots 104a-104f, video segments may be retrieved directly from recorder 14 without input from local server 16, may be retrieved via local server 16, or may be retrieved directly from recorder 14 using instructions provided by local server 16. Play input device 116 plays back video segments associated with first selected image 108 and second selected image 110, as is explained in further detail below with respect to FIGS. 3A and 3B.

Filmstrip snapshots 104 are drawn at regular intervals from recorded video stored on at least one recorder 14. Each filmstrip snapshot 104 is separated from adjacent filmstrip snapshots by a time interval determined by a zoom level of filmstrip panel 102, which may be adjusted with zoom-in input device 112 and zoom-out input device 114. Pressing zoom-in input device 114 causes client device 18 to retrieve and display a new set filmstrip snapshots 104 separated by a shorter time interval. Conversely, pressing zoom-out input device 116 causes client device 18 to retrieve and display a new set of filmstrip snapshots 104 separated by a longer time interval. In some embodiments, filmstrip intervals at every zoom level are “even” or “neat” time periods, such as one hour, fifteen minute, or one minute. Graphical user interface 100 may support any number of zoom levels, although only two to five levels will be useful for most video searching applications.

Forward input device 118 and reverse input device 120 allow a user to shift filmstrip snapshot sequence 104 as if spooling through a filmstrip. Activating forward input device 118 advances the sequence of filmstrip snapshots 104a-104f by one, such that filmstrip snapshot 104d becomes first selection image 108, and filmstrip snapshot 104e becomes second selection image 110. Analogously, pressing reverse input device 120 retreats the sequence of filmstrip snapshots 104a-104f by one, such that filmstrip snapshot 104b becomes first selection image 108, and filmstrip snapshot 104c becomes second filmstrip snapshot 110. In some embodiments, forward input device 118 and reverse input device 120 are mouse swipes, such that dragging or scrolling across filmstrip snapshot sequence 104 advances or retreats chronologically through filmstrip snapshot sequence 104. Alternatively, filmstrip panel 102 may include separate mechanisms for advancing or retreating filmstrip snapshot sequence 104 incrementally or via a scan. In still other embodiments, forward input device 118 and reverse input device 120 may be scan buttons that cause filmstrip snapshot sequence 104 to advance or retreat automatically at a moderate rate until stopped. Some embodiments of graphical user interface 100 may provide more than one of these options, e.g. both an automatic advancement button and the capacity to advance and retreat filmstrip snapshot sequence 104 with a mouse swipe.

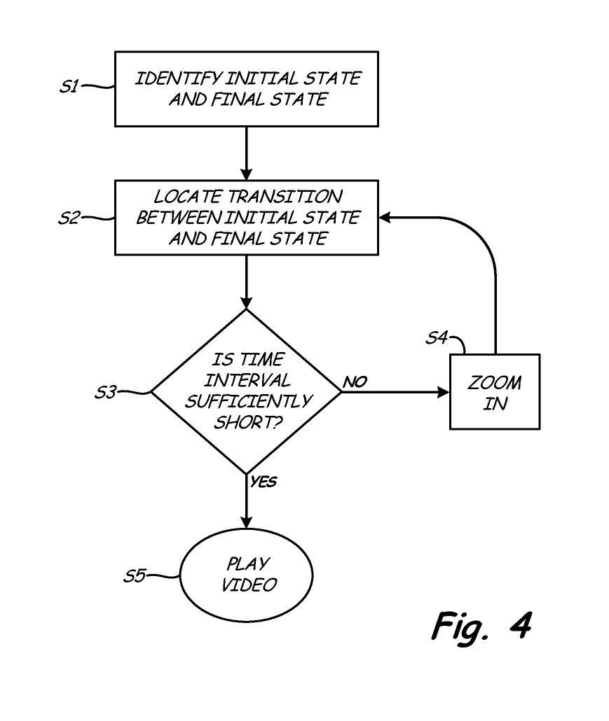

Graphical user interface 100 can be used to play back recorded video, as described above, and to search recorded video, as described below with respect to FIG. 4. In addition the elements enumerated above, graphical user interface 100 may include such secondary elements as a camera information display (indicating which source 12 video comes from), a time indicator (indicating the timestamp for each filmstrip snapshot 104N), and a quality monitor (indicating the encoded video frame rate and/or resolution).

FIGS. 3A and 3B are timelines advancing chronologically from left to right, depicting video segment sequences 200 and 300, respectively. Video segment sequence 200 includes video segments vs1, vs2, vs3, and vs4, while video segment sequence 300 includes video segments vs5, vs6, vs7, vs8, vs9, and vs10. Each video segment vs1, vs2, . . . vs10 correspond to some displayed or potential filmstrip snapshots 104N described above with respect to FIG. 2. FIG. 3A depicts a first zoom level, while FIG. 3B depicts a second, higher zoom level; in particular, FIG. 3B depicts one possible timeline of video segments which could be obtained from the timeline of FIG. 3A by pressing zoom-in input device 112. Each video segment vsN has a start time stN and an end time etN separated by a regular time interval T. All video segments in FIG. 3A have a duration defined by time interval T1, while all video segments in FIG. 3B have a duration defined by shorter time interval T2, representing in increase in zoom between FIG. 3A and FIG. 3B. End time etN of each video segment vsN within video sequences 200 or 300 substantially matches start time stN+1 of subsequent video segment vsN+1. Slight variations in the length of each video segment may occur where time interval T is not a perfect multiple of a recording frame rate of video encoded by recorder 14.

Selection S1 includes video segments vs2 and vs3, which correspond to first selected image 108 and second selected image 110, respectively. When a user presses play input device 116 (see FIG. 2, above), client device 18 plays back the entirety of selection S1, beginning at start time st2 and ending at end time et3. For systems wherein selection window 106 encloses more than two filmstrip snapshots 104, selection S1 will correspondingly include more than two video segments, all of which will be played back, in order, when play input device 116 is pressed. Selection S2 is a higher-zoom analogue of selection S1, and accordingly spans a shorter time. Selection S2 includes video segments vs7 and vs8, starts at start time st7, and ends at end time et8. In some embodiments, only the current selection (S1 or S2) will be played in when play input device 116 is perssed

Video segment sequences 200 and 300 and filmstrip snapshot sequence 104 are centered on time t₀. Accordingly, time t₀ represents the midpoint of both selection S1 and selection S2, such that t₀=et2=st3=et7=st8 in the depicted embodiment. Pressing zoom-in input device 112 or zoom-out input device 114 causes user interface 100 to zoom in or out about time t₀, such that time t₀ remains the midpoint time of the video sequence corresponding to post-zoom filmstrip snapshot sequence 104.

Graphical user interface 100 provides allows a user at client device 18 to easily recognize, select, and play a desired selection S by positioning appropriate filmstrip snapshots 104a-104f within selection window 106 using forward input device 118 and reverse input device 120, and pressing play input device 116. Graphical user interface 100 can also be used to search video for transition events, as described below with respect to FIG. 4.

FIG. 4 is a flow chart of a method for locating and viewing transition events using graphical user interface 100. Some events result in a lasting change to recorded video area, such that a first state before the event differs visibly from a second state after the event; these events are referred to herein as “transition” events. The theft of a painting or the breaking of a window, for instance, will result in lasting change to the environment, viz. the absence of the painting or window. Transition events can be recognized using graphical user interface 100 by identifying a difference between a before-state visible in an earlier filmstrip snapshot 104N, and an after-state visible in a later filmstrip snapshot 104M (where N<M). (Step S1). At a low zoom level corresponding to a long time interval T, a user can detect at a glance whether a transition event has occurred during the long time period corresponding to filmstrip snapshot sequence 104. Similarly, a user can locate a known transition event by advancing through filmstrip snapshot sequence 104 with forward input device 118 and reverse input device 120, until first selected image 108 differs from second selected image 110 in the expected way (e.g. a painting that is present in first selected image 108 is missing from second selected image 110). (Step S2).Once the transition has been located within selection window 106, a user determines whether the time span included in the selection window 106 is sufficiently short. (Step S3). The smashing of a car windshield, for instance, might take place in a matter of seconds, making it inefficient for a user to play back an entire two hour selected video clip comprised of two selected one hour video segments. Accordingly, the user can zoom in as described above with respect to FIGS. 2, 3A, and 3B, shortening time interval T to a more manageable value. (Step S4). After shortening the time interval, the user can repeat this process, locating the transition event progressively more precisely in time (Step S2), and continuing to zoom in (Step S4) until selection window 106 encloses a sufficiently brief clip encompassing the transition event. Longer playback intervals may be appropriate for lengthier events. Once the selected video is sufficiently short, a user can press play input device 116 to play back the selected clip, as described above with respect to FIG. 2. (Step S5).

The present invention allows a user to quickly locate transition events in recorded video without playing through a large volume of irrelevant video. Once such a transition event has been located, a user can quickly and easily select an appropriate video clip for playback, and play that video clip.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A user interface for searching and playing recorded video, the user interface comprising:
a filmstrip snapshot sequence of a series of chronologically ordered snapshots of the recorded video, each snapshot having an associated video segment of the recorded video from which the snapshot was taken, and wherein each of the snapshots is taken at a regular interval equal to the length of the video segments;
a selection window which highlights a set of at least two consecutive snapshots from the filmstrip snapshot sequence;
a first input device that, when activated, advances the filmstrip snapshot sequence, causing the selection window to highlight a chronologically later set of snapshots;
a second input device that, when activated, zooms in on the filmstrip snapshot sequence as a function of time, causing a new set of snapshots to be retrieved at a smaller regular interval;
a third input device that when activated, plays the video segments associated with the highlighted snapshots, in chronological order.

2. The user interface of claim 1, wherein at least one of the first, second, and third input devices is a dragable or clickable interface icon, a GUI region responsive to mouse clicks, or some other equivalent software input device, such that activating that input device is accomplished by selecting the icon or GUI region.

3. The user interface of claim 1, further comprising a fourth input device that, when activated, zooms out on the filmstrip snapshot sequence, causing a new set of snapshots to be retrieved at a larger regular interval.

4. The user interface of claim 1, wherein the first input device is a forward button that advances the filmstrip snapshot sequence by a fixed increment.

5. The user interface of claim 1, wherein the first input device is a scan button that causes the filmstrip snapshot sequence to advance automatically until stopped.

6. The user interface of claim 1, further comprising a fifth input device that, when activated, retreats the filmstrip snapshot sequence, causing the selection window to highlight a set of chronologically earlier set of snapshots.

7. The user interface of claim 6, wherein the first and fifth input devices are mouse swipes that respectively advance and retreat the filmstrip snapshot sequence.

8. The user interface of claim 1, wherein the new snapshots retrieved at a smaller regular interval are centered in time about a period corresponding to the two consecutive snapshots highlighted by the selection window.

9. The user interface of claim 1, further comprises a plurality of similar filmstrip snapshot sequences, such that each filmstrip snapshot sequence includes snapshots associated with video from a single separate video source.

10. A video capture and playback network comprising:
a video source;
a recorder which encodes video from the video source; and
a client device which enables a user to search and play back encoded video from the recorder via a user interface comprising:
a filmstrip snapshot sequence of a series of chronologically ordered snapshots of the encoded video, each snapshot having an associated video segment of the encoded video from which the snapshot was taken, and wherein each of the snapshots is taken at a regular interval equal to the length of the video segments;
a selection window which highlights a set of at least two consecutive snapshots from the filmstrip snapshot sequence;
a first icon or equivalent input device which, when selected, advances the filmstrip snapshot sequence, causing the selection window to highlight a chronologically later set of snapshots;
a second icon or equivalent input device which, when selected, zooms in on the filmstrip snapshot sequence as a function of time, causing a new set of snapshots to be retrieved at a smaller regular interval;
a third icon or equivalent input device which, when selected, plays the video segments associated with the highlighted snapshots, in chronological order.

11. The video capture and playback network of claim 10, further comprising a video management server which catalogues, retrieves, or processes video from the recorder for playback at the client device.

12. The video capture and playback network of claim 10, wherein the user interface further comprises a fourth icon or equivalent input device which, when selected, zooms out on the filmstrip snapshot sequence, causing a new set of snapshots to be retrieved at a larger regular interval.

13. The video capture and playback network of claim 10, wherein the user interface further comprises a fifth icon or equivalent input device which, when selected, retreats the filmstrip snapshot sequence, causing the selection window to highlight a set of chronologically earlier set of snapshots.

14. The video capture and playback network of claim 10, wherein the new snapshots retrieved at a smaller regular interval are centered in time about a period corresponding to the two consecutive snapshots highlighted by the selection window.

15. The video capture and playback network of claim 10, further comprising at least a second recorder which also encodes video from the video source, and wherein the encoded video is stored on a combination of the first recorder and the second recorder.

16. The video capture and playback network of claim 10, further comprising a second video source and a second source recorder which encodes video from the second source, wherein the interface comprises a second filmstrip snapshot sequence including snapshots associated with video from the second source recorder.

17. A method for locating a transition event on recorded video with a user interface, the method comprising;
identifying an initial state and a final state which are visually distinguishable from snapshots of the recorded video;
advancing a chronological sequence of snapshots taken at a regular time interval from the recorded video, until a snapshot showing the first state and a snapshot showing the second state are simultaneously highlighted by a selection window of the user interface; and
playing video associated with snapshots highlighted by the selection window.

18. The method of claim 17, further comprising, prior to pressing the play button:
ascertaining whether the regular time interval is of an appropriate length for viewing the transition event, and if not:
providing a zoom command to produce a new chronological sequence of snapshots with a greater or smaller regular time interval; and
advancing the new chronological sequence of snapshots until a new snapshot showing the first state and a new snapshot showing the second state are simultaneously highlighted by the selection window of the user interface.

19. The method of claim 18, wherein providing a zoom command comprises pressing a zoom-in button which produces a new chronological sequence of snapshots with a smaller regular time interval.

20. The method of claim 19, wherein providing a zoom command comprises pressing a zoom-out button which produces a new chronological sequence of snapshots with a larger regular time interval.
